(19) United States
(12) Patent Application Publication
(10) Pub. No.: US 2024/0314705 A1
(43) Pub. Date: Sep. 19, 2024

(54) ELECTRONIC DEVICE SUPPORTING NON-TERRESTRIAL NETWORK COMMUNICATION AND METHOD FOR OPERATING THE SAME

(71) Applicant: SAMSUNG ELECTRONICS CO., LTD., Suwon-si (KR)

(72) Inventors: Kyujae JANG, Suwon-si (KR); Jimin KOO, Suwon-si (KR); Dohun KIM, Suwon-si (KR); Cheonshik KIM, Suwon-si (KR); Yongjun AN, Suwon-si (KR); Yeonsang YUN, Suwon-si (KR); Sungyoul CHO, Suwon-si (KR)

(21) Appl. No.: 18/604,962

(22) Filed: Mar. 14, 2024

Related U.S. Application Data
(63) Continuation of application No. PCT/KR2024/003161, filed on Mar. 12, 2024.

(30) Foreign Application Priority Data
Mar. 14, 2023 (KR) 10-2023-0033449
Apr. 7, 2023 (KR) 10-2023-0046271

(51) Int. Cl. H04W 52/28; G01S 19/39; G01S 19/51

(52) U.S. Cl. CPC H04W 52/283; G01S 19/393; G01S 19/51

(57) ABSTRACT

According to an embodiment, an electronic device may comprise: memory storing instructions and at least one processor, comprising processing circuitry, individually and/or collectively. The instructions, when executed by at least one processor, cause the electronic device to: identify a position of the electronic device and at least one satellite from a GPS signal based on identifying a first event, identify whether a value based on a relative angle between a trajectory axis corresponding to the at least one satellite and the electronic device meets a first condition, identify whether a value based on a relative distance between the electronic device and the at least one satellite meets a second condition based on identifying that the value based on the relative angle does not meet the first condition, set a first power lower than a third power to a transmission power of a transmission signal corresponding to satellite communication based on identifying that the value based on the relative distance meets the second condition, and set a third power to a transmission power of a transmission signal corresponding to satellite communication based on identifying that the value based on the relative distance does not meet the second condition.

### CROSS-REFERENCE TO RELATED APPLICATIONS

This application is a continuation of International Application No. PCT/KR2024/003161 designating the United States, filed on Mar. 12, 2024, in the Korean Intellectual Property Receiving Office and claiming priority to Korean Patent Application Nos. 10-2023-0033449, filed on Mar. 14, 2023, and 10-2023-0046271, filed on Apr. 7, 2023, the disclosures of each of which are incorporated by reference herein in their entireties.

### BACKGROUND

### Field

The disclosure relates to an electronic device supporting non-terrestrial network communication and a method for operating the same.

### Description of Related Art

Recently, electronic devices supporting non-terrestrial network communication (e.g., satellite communication) are being actively introduced. As an example, an electronic device may communicate with a satellite of a satellite communication company using the frequency and communication scheme of the company. As an example, an electronic device may communicate with a satellite using a long-term evolution (LTE) standard cellular frequency based on the LTE standard (or 5G standard). As an example, an electronic device may communicate with a satellite based on the 5G non-terrestrial networks (NTN) standard.

For example, when an electronic device communicates with a non-terrestrial network based on the LTE standard, some of the frequencies defined in the LTE standard may be allocated for non-terrestrial communication. An electronic device may perform satellite communication using a protocol stack used in terrestrial communication and may require no further protocol stack for non-terrestrial communication.

### SUMMARY

According to an example embodiment, an electronic device may comprise memory storing instructions and at least one processor comprising processing circuitry. The instructions, when executed by at least one processor individually and/or collectively, may cause the electronic device to: identify a position of the electronic device and at least one satellite from a GPS signal based on identifying a first event; identify whether a value based on a relative angle between a trajectory axis corresponding to the at least one satellite and the electronic device satisfies a first condition; identify whether a value based on a relative distance between the electronic device and the at least one satellite satisfies a second condition based on identifying that the value based on the relative angle does not satisfy the first condition; set a first power lower than a third power to a transmission power of a transmission signal corresponding to satellite communication based on identifying the value based on the relative distance satisfying the second condition; and to set a third power to a transmission power of a transmission signal corresponding to satellite communication based on identifying that the value based on the relative distance does not satisfy the second condition.

According to an example embodiment, in a non-transitory storage medium storing at least one computer-readable instruction, the at least one instruction may, when executed by at least one processor, individually and/or collectively, of an electronic device, may cause the electronic device to perform at least one operation, comprising: identifying a position of the electronic device and at least one satellite from a GPS signal based on identifying a first event; identifying whether a value based on a relative angle between a trajectory axis corresponding to the at least one satellite and the electronic device satisfies a first condition; identifying whether a value based on a relative distance between the electronic device and the at least one satellite satisfies a second condition based on identifying that the value based on the relative angle does not satisfy the first condition;

setting a first power lower than a third power to a transmission power of a transmission signal corresponding to satellite communication based on identifying the value based on the relative distance satisfying the second condition; and setting a third power to a transmission power of a transmission signal corresponding to satellite communication based on identifying that the value based on the relative distance does not satisfy the second condition.

According to an example embodiment, a method for operating an electronic device may comprise: identifying a position of the electronic device and at least one satellite from a GPS signal based on identifying a first event; identifying whether a value based on a relative angle between a trajectory axis corresponding to the at least one satellite and the electronic device satisfies a first condition; identifying whether a value based on a relative distance between the electronic device and the at least one satellite satisfies a second condition based on identifying that the value based on the relative angle does not satisfy the first condition; setting a first power lower than a third power to a transmission power of a transmission signal corresponding to satellite communication based on identifying the value based on the relative distance satisfying the second condition; and setting a third power to a transmission power of a transmission signal corresponding to satellite communication based on identifying that the value based on the relative distance does not satisfy the second condition.

According to an example embodiment, an electronic device may comprise memory storing instructions and at least one processor comprising processing circuitry. The instructions, when executed by at least one processor, individually and/or collectively, may cause the electronic device to: identify a position of the electronic device from a GPS signal based on identifying a first event; identify whether a latitude corresponding to the position of the electronic device is within a first range; and set a power lower than a third power to a transmission power of a transmission signal corresponding to satellite communication based on identifying that the latitude corresponding to the position of the electronic device is not within the first range.

According to an example embodiment, in a non-transitory storage medium storing at least one computer-readable instruction, the at least one instruction may, when executed by at least one processor, individually and/or collectively, of an electronic device, cause the electronic device to perform at least one operation, comprising: identifying a position of the electronic device from a GPS signal based on identifying a first event; identifying whether a latitude corresponding to the position of the electronic device is within a first range; and setting a power lower than a third power to a transmission power of a transmission signal corresponding to satellite communication based on identifying that the latitude corresponding to the position of the electronic device is not within the first range.

According to an example embodiment, a method for operating an electronic device may comprise: identifying a position of the electronic device from a GPS signal based on identifying a first event; identifying whether a latitude corresponding to the position of the electronic device is within a first range; and setting a power lower than a third power to a transmission power of a transmission signal corresponding to satellite communication based on identifying that the latitude corresponding to the position of the electronic device is not within the first range.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2A is a block diagram illustrating an example configuration of an electronic device for supporting legacy network communication and 5G network communication according to various embodiments;

FIG. 2B is a block diagram illustrating an example configuration of an electronic device for supporting legacy network communication and 5G network communication according to various embodiments;

FIG. 3 is a diagram illustrating access to an electronic device according to various embodiments;

FIG. 4 is a block diagram illustrating an example configuration of an electronic device for supporting non-terrestrial network communication according to various embodiments;

FIG. 5A is a diagram illustrating a satellite communication system according to various embodiments;

FIG. 5B is a diagram illustrating a satellite communication system according to various embodiments;

FIG. 6 is a diagram illustrating a relative distance between an electronic device and a satellite according to various embodiments;

FIG. 7 is a flowchart illustrating an example method of operating an electronic device according to various embodiments;

FIG. 8 is a graph illustrating an example of controlling transmission power over time by an electronic device according to various embodiments;

FIG. 9A is a flowchart illustrating an example method of operating an electronic device according to various embodiments;

FIG. 9B is a flowchart illustrating an example method of operating an electronic device according to various embodiments;

FIG. 9C is a flowchart illustrating an example method of operating an electronic device according to various embodiments;

FIG. 10 is a flowchart illustrating an example method of operating an electronic device according to various embodiments; and

FIG. 11 is a flowchart illustrating an example method of operating an electronic device according to various embodiments.

### DETAILED DESCRIPTION

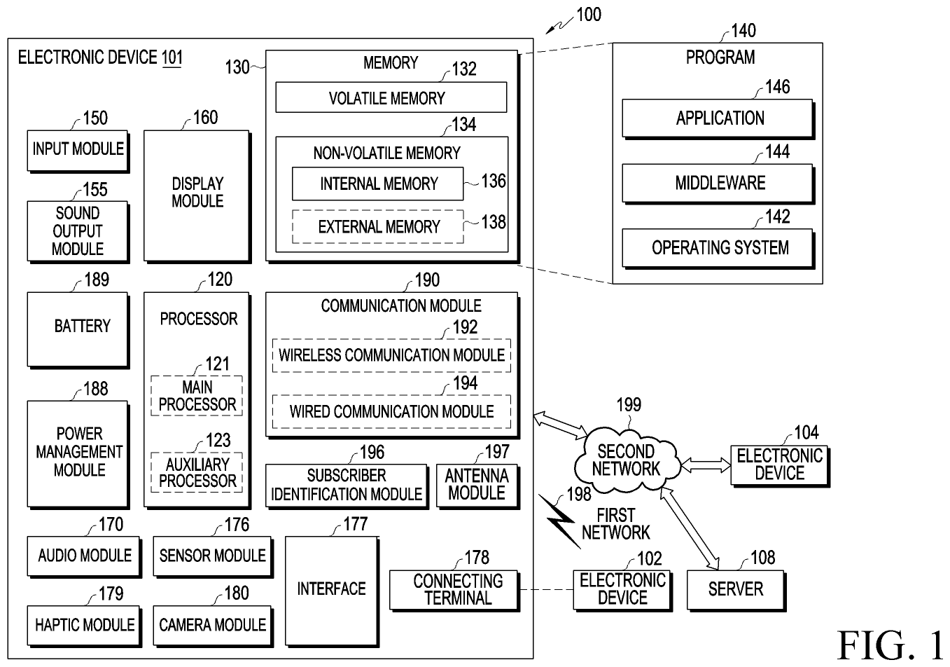

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal According to an embodiment, the display module 160 may include a first display module 351 corresponding to the user's left eye and/or a second display module 353 corresponding to the user's right eye., a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196. The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductive body or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

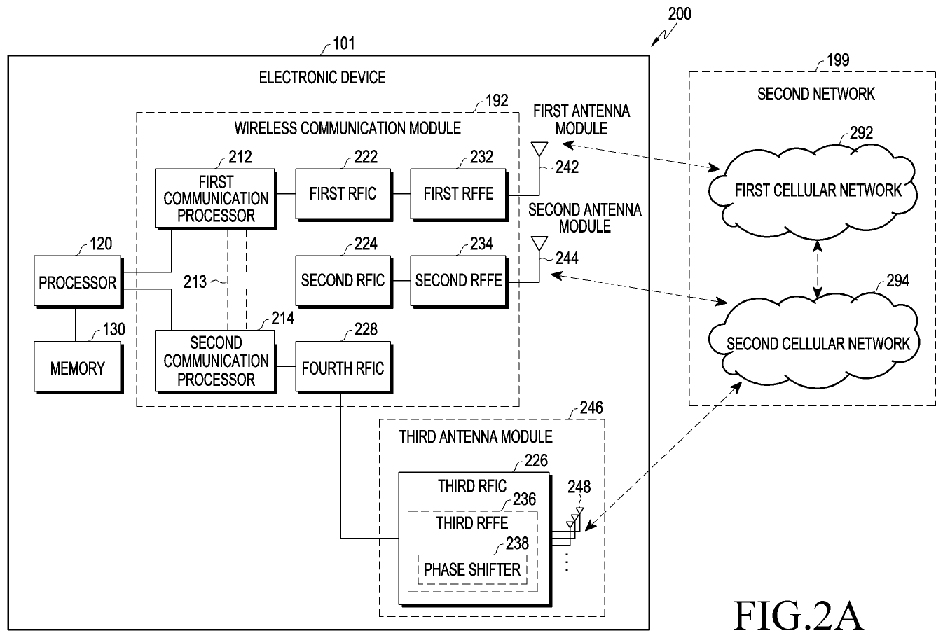

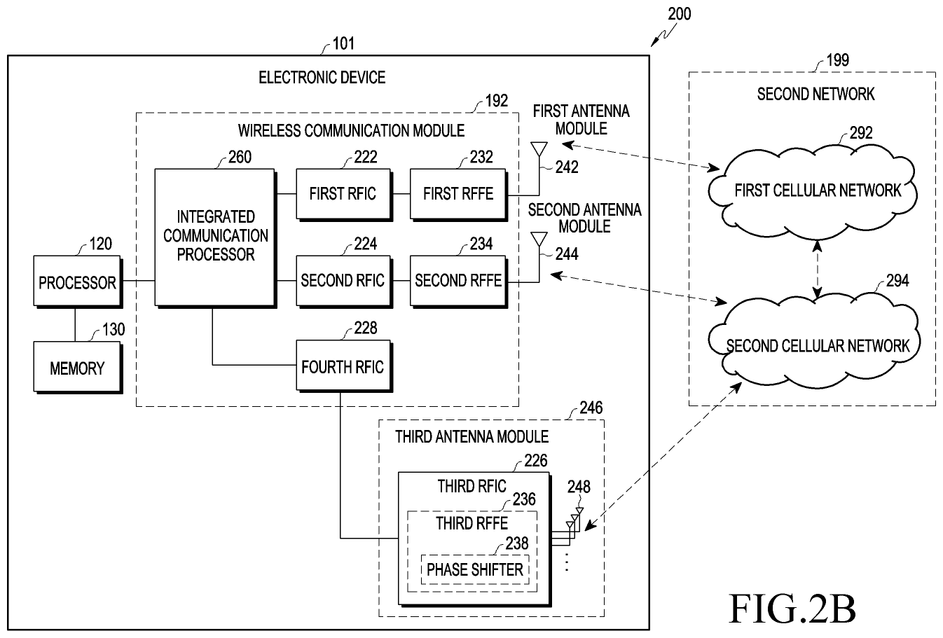

FIG. 2A is a block diagram 200 illustrating an example configuration of an electronic device 101 for supporting legacy network communication and 5G network communication according to various embodiments. Referring to FIG. 2A, the electronic device 101 may include a first communication processor (e.g., including processing circuitry) 212, a second communication processor (e.g., including processing circuitry) 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, a third antenna module 246, and antennas 248. The electronic device 101 may further include a processor (e.g., including processing circuitry) 120 and a memory 130. The second network 199 may include a first cellular network 292 and a second cellular network 294. According to an embodiment, the electronic device 101 may further include at least one component among the components of FIG. 1, and the second network 199 may further include at least one other network. According to an embodiment, the first communication processor 212, the second communication processor 214, the first RFIC 222, the second RFIC 224, the fourth RFIC 228, the first RFFE 232, and the second RFFE 234 may form at least part of the wireless communication module 192. According to an embodiment, the fourth RFIC 228 may be omitted or be included as part of the third RFIC 226.

The first communication processor 212 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The first communication processor 212 may, for example, establish a communication channel of a band that is to be used for wireless communication with the first cellular network 292 or may support legacy network communication via the established communication channel. According to an embodiment, the first cellular network may be a legacy network that includes second generation (2G), third generation (3G), fourth generation (4G), or long-term evolution (LTE) networks. The second communication processor 214 may establish a communication channel corresponding to a designated band (e.g., from about 6 GHz to about 60 GHz) among bands that are to be used for wireless communication with the second cellular network 294 or may support fifth generation (5G) network communication via the established communication channel. According to an embodiment, the second cellular network 294 may be a 5G network defined by the 3rd generation partnership project (3GPP). Additionally, according to an embodiment, the first communication processor 212 or the second communication processor 214 may establish a communication channel corresponding to another designated band (e.g., about 6 GHz or less) among the bands that are to be used for wireless communication with the second cellular network 294 or may support fifth generation (5G) network communication via the established communication channel. The second communication processor 214 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The first communication processor 212 may perform data transmission/reception with the second communication processor 214. For example, data classified as transmitted via the second cellular network 294 may be changed to be transmitted via the first cellular network 292. In this case, the first communication processor 212 may receive transmission data from the second communication processor 214. For example, the first communication processor 212 may transmit/receive data to/from the second communication processor 214 via an inter-processor interface 213. The inter-processor interface 213 may be implemented as, e.g., universal asynchronous receiver/transmitter (UART) (e.g., high speed-UART (HS-UART)) or peripheral component interconnect bus express (PCIe) interface, but is not limited to a specific kind. The first communication processor 212 and the second communication processor 214 may exchange packet data information and control information using, e.g., a shared memory. The first communication processor 212 may transmit/receive various types of information, such as sensing information, information about output strength, and resource block (RB) allocation information, to/from the second communication processor 214.

According to implementation, the first communication processor 212 may not be directly connected with the second communication processor 214. In this case, the first communication processor 212 may transmit/receive data to/from the second communication processor 214 via a processor 120 (e.g., an application processor). For example, the first communication processor 212 and the second communication processor 214 may transmit/receive data to/from the processor 120 (e.g., an application processor) via an HS-UART interface or PCIe interface, but the kind of the interface is not limited thereto. The first communication processor 212 and the second communication processor 214 may exchange control information and packet data information with the processor 120 (e.g., an application processor) using a shared memory.

According to an embodiment, the first communication processor 212 and the second communication processor 214 may be implemented in a single chip or a single package. According to an embodiment, the first CP 212 or the second CP 214, along with the processor 120, an auxiliary processor 123, or communication module 190, may be formed in a single chip or single package. For example, as shown in FIG. 2B, an integrated communication processor 260 may support all of the functions for communication with the first cellular network 292 and the second cellular network 294. The integrated communication processor 260 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

As described above, at least one of the processor 120, the first communication processor 212, the second communication processor 214, or the integrated communication processor 260 may be implemented as a single chip or a single package. In this case, the single chip or single package may include a memory (or storage means) storing instructions that cause at least some of operations performed according to an embodiment and a processing circuit (or operation circuit, but the term is not limited) for executing instructions.

Upon transmission, the first RFIC 222 may convert a baseband signal generated by the first communication processor 212 into a radio frequency (RF) signal with a frequency ranging from about 700 MHz to about 3 GHz which is used by the first cellular network 292 (e.g., a legacy network). Upon receipt, the RF signal may be obtained from the first network 292 (e.g., a legacy network) through an antenna (e.g., the first antenna module 242) and be pre-processed via an RFFE (e.g., the first RFFE 232). The first RFIC 222 may convert the pre-processed RF signal into a baseband signal that may be processed by the first communication processor 212.

Upon transmission, the second RFIC 224 may convert the baseband signal generated by the first communication processor 212 or the second communication processor 214 into a Sub6-band (e.g., about 6 GHz or less) RF signal (hereinafter, “5G Sub6 RF signal”) that is used by the second cellular network 294 (e.g., a 5G network). Upon receipt, the 5G Sub6 RF signal may be obtained from the second cellular network 294 (e.g., a 5G network) through an antenna (e.g., the second antenna module 244) and be pre-processed via an RFFE (e.g., the second RFFE 234). The second RFIC 224 may convert the pre-processed 5G Sub6 RF signal into a baseband signal that may be processed by a corresponding processor of the first communication processor 212 and the second communication processor 214.

The third RFIC 226 may convert the baseband signal generated by the second CP 214 into a 5G Above6 band (e.g., from about 6 GHz to about 60 GHz) RF signal (hereinafter, “5G Above6 RF signal”) that is to be used by the second cellular network 294 (e.g., a 5G network). Upon receipt, the 5G Above6 RF signal may be obtained from the second cellular network 294 (e.g., a 5G network) through an antenna (e.g., the antenna 248) and be pre-processed via the third RFFE 236. The third RFIC 226 may convert the pre-processed 5G Above6 RF signal into a baseband signal that may be processed by the second communication processor 214. According to an embodiment, the third RFFE 236 may be formed as part of the third RFIC 226.

According to an embodiment, the electronic device 101 may include the fourth RFIC 228 separately from, or as at least part of, the third RFIC 226. In this case, the fourth RFIC 228 may convert the baseband signal generated by the second communication processor 214 into an intermediate frequency band (e.g., from about 9 GHz to about 11 GHz) RF signal (hereinafter, “IF signal”) and transfer the IF signal to the third RFIC 226. The third RFIC 226 may convert the IF signal into a 5G Above6 RF signal. Upon receipt, the 5G Above6 RF signal may be received from the second cellular network 294 (e.g., a 5G network) through an antenna (e.g., the antenna 248) and be converted into an IF signal by the third RFIC 226. The fourth RFIC 228 may convert the IF signal into a baseband signal that may be processed by the second communication processor 214.

According to an embodiment, the first RFIC 222 and the second RFIC 224 may be implemented as at least part of a single chip or single package. According to an embodiment, when the first RFIC 222 and the second RFIC 224 in FIG. 2A or 2B are implemented as a single chip or a single package, they may be implemented as an integrated RFIC. In this case, the integrated RFIC is connected to the first RFFE 232 and the second RFFE 234 to convert a baseband signal into a signal of a band supported by the first RFFE 232 and/or the second RFFE 234, and may transmit the converted signal to one of the first RFFE 232 and the second RFFE 234. According to an embodiment, the first RFFE 232 and the second RFFE 234 may be implemented as at least part of a single chip or single package. According to an embodiment, at least one of the first antenna module 242 or the second antenna module 244 may be omitted or be combined with another antenna module to process multi-band RF signals.

According to an embodiment, the third RFIC 226 and the antenna 248 may be disposed on the same substrate to form the third antenna module 246. For example, the wireless communication module 192 or the processor 120 may be disposed on a first substrate (e.g., a main painted circuit board (PCB)). In this case, the third RFIC 226 and the antenna 248, respectively, may be disposed on one area (e.g., the bottom) and another (e.g., the top) of a second substrate (e.g., a sub PCB) which is provided separately from the first substrate, forming the third antenna module 246. Placing the third RFIC 226 and the antenna 248 on the same substrate may shorten the length of the transmission line therebetween. This may reduce a loss (e.g., attenuation) of high-frequency band (e.g., from about 6 GHz to about 60 GHz) signal used for 5G network communication due to the transmission line. Thus, the electronic device 101 may enhance the communication quality with the second network 294 (e.g., a 5G network).

According to an embodiment, the antenna 248 may be formed as an antenna array which includes a plurality of antenna elements available for beamforming. In this case, the third RFIC 226 may include a plurality of phase shifters 238 corresponding to the plurality of antenna elements, as part of the third RFFE 236. Upon transmission, the plurality of phase shifters 238 may change the phase of the 5G Above6 RF signal which is to be transmitted to the outside (e.g., a 5G network base station) of the electronic device 101 via their respective corresponding antenna elements. Upon receipt, the plurality of phase shifters 238 may change the phase of the 5G Above6 RF signal received from the outside to the same or substantially the same phase via their respective corresponding antenna elements. This enables transmission or reception via beamforming between the electronic device 101 and the outside.

The second cellular network 294 (e.g., a 5G network) may be operated independently (e.g., as standalone (SA)) from, or in connection (e.g., as non-standalone (NSA)) with the first cellular network 292 (e.g., a legacy network). For example, the 5G network may have the access network (e.g., 5G radio access network (RAN) or next generation RAN (NG RAN)) but may not have the core network (e.g., next generation core (NGC)). In this case, the electronic device 101, after accessing a 5G network access network, may access an external network (e.g., the Internet) under the control of the core network (e.g., the evolved packet core (EPC)) of the legacy network. Protocol information (e.g., LTE protocol information) for communication with the legacy network or protocol information (e.g., New Radio (NR) protocol information) for communication with the 5G network may be stored in the memory 230 and be accessed by other components (e.g., the processor 120, the first communication processor 212, or the second communication processor 214).

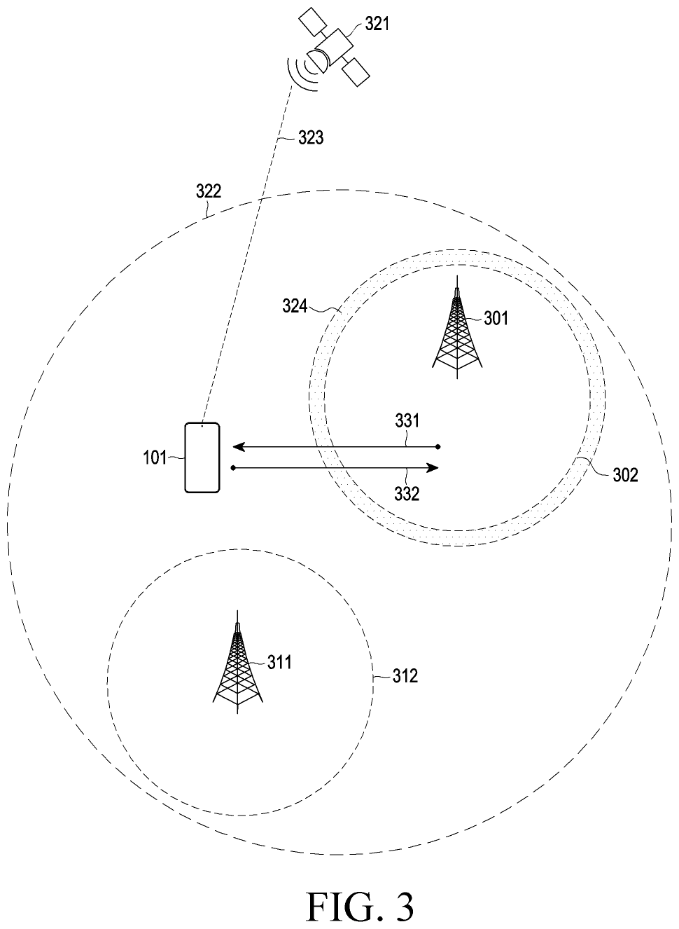

FIG. 3 is a diagram illustrating access to an electronic device according to various embodiments.

According to an embodiment, the electronic device 101 may be positioned within the coverage 322 of the satellite 321. It will be appreciated by one of ordinary skill in the art that the satellite 321 may be replaced with another type of electronic device supporting non-terrestrial communication in various embodiments of the disclosure. The electronic device 101 may access (323) the satellite 321 within the coverage 322 of the satellite 321. For example, the electronic device 101 may perform a cell scan within the coverage 322 of the satellite 321. The electronic device 101 may identify the satellite 321 (which may be referred to as a cell corresponding to the satellite 321) as a result of performing the cell scan. When the satellite 321 meets a cell selection condition, the electronic device 101 may camp on the satellite 321. The electronic device 101 may camp on the satellite 321 and may perform at least one operation for establishing a connection (e.g., radio resource control (RRC) connection) with the satellite 321. The electronic device 101 may perform at least one operation for attachment (or registration) to a core network (e.g., MME or AMF) corresponding to the satellite 321, based on the established connection. The access 323 to the satellite 321 may include, e.g., camping on, establishing a connection, and/or attaching, but is not limited thereto. The coverage 322 of satellite communication may be relatively wider (e.g., 50 times wider) than the coverage 302 and 312 by the terrestrial base stations 301 and 311. The coverage 322 based on satellite communication may cover, e.g., an area not covered by the coverage 302 and 312 by terrestrial communication, and accordingly, the user may perform communication using the electronic device 101 even in an area where terrestrial communication is not supported.

For example, satellite communication based on the satellite 321 may support limited frequency resources and/or limited services. Satellite communication may provide, e.g., a limited service such as an emergency service (e.g., an emergency call) and/or a short message service (SMS), and may not support a service (e.g., video streaming, but not limited thereto) for transmitting and receiving other general data. Satellite communication may support a limited bandwidth (e.g., 1.4 MHz) compared to terrestrial communication. For example, in satellite communication, even when a voice call and/or a data service is supported, the entire cell capacity may be relatively low as 2 to 4 Mbps. On the other hand, the terrestrial communication may support a bandwidth of up to, e.g., 100 MHz when carrier aggregation (CA) is activated, and the cell capacity may also exceed 1 Gbps. In an embodiment, the electronic device 101 may move (331) out of the coverage 302 from a position within the coverage 302 by terrestrial communication, or may move (332) into the coverage 302 from out of the coverage 302. In an embodiment, the electronic device 101 may be positioned in the boundary area 324 of the coverage 302 by terrestrial communication. Even after the electronic device 101 accesses the satellite 321 (323), if the terrestrial base stations 301 and 311 are detected based on the position of the electronic device 101, the electronic device 101 may access the terrestrial base stations 301 and 311.

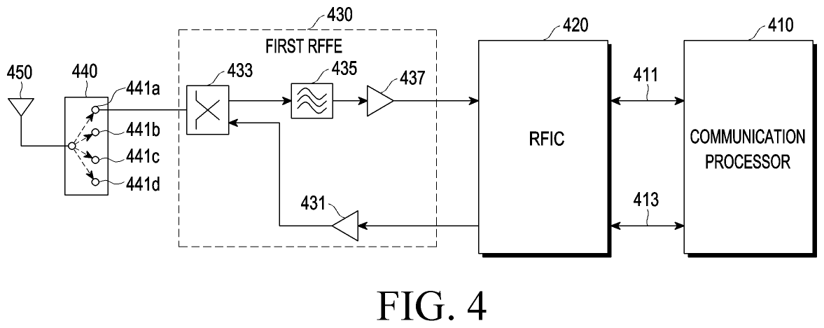

FIG. 4 is a block diagram illustrating an example configuration of an electronic device for supporting non-terrestrial network communication according to various embodiments.

Referring to FIG. 4, an electronic device 101 may include an antenna module (e.g., including at least one antenna) 450, an antenna switch module (e.g., including at least one switch) 440, a first RFFE 430, at least one RFIC 420, and at least one communication processor (e.g., including processing circuitry)_410.

In an embodiment, the antenna module (e.g., the antenna module 197, the first antenna module 242, the second antenna module 244, the third antenna module 246, and/or the antennas 248) may radiate an RF signal or receive a signal from the outside. The antenna module 450 may transmit and receive a signal corresponding to, e.g., non-terrestrial network communication. Although FIG. 4 illustrates only one antenna module for convenience of description, those skilled in the art will understand that the electronic device 101 includes a plurality of antenna modules.

In an embodiment, the antenna switch module 440 may change a transmission/reception path of a signal based on switching. The antenna switch module 440 may perform switching based on a control signal received from the at least one RFIC 420 and/or the at least one communication processor 410. For example, the antenna switch module 440 may electrically connect the antenna module 450 and the first RFFE 430 based on activation of a first output port 441a. The antenna switch module 440 may electrically connect the antenna module 450 and at least one other RFFE (not shown), based on activation of at least one of the first output port 441b, the second output port 441c, or the third output port 441d. In an embodiment, at least one other RFFE may process a signal corresponding to a legacy communication network. For example, at least one other RFFE may process GNSS signals, Wi-Fi signals, or signals corresponding to network communication (e.g., 4G network communication or 5G network communication) by terrestrial base stations (e.g., the terrestrial base stations 301 and 311), but is not limited thereto.

In an embodiment, the first RFFE 430 may process an RF signal corresponding to non-terrestrial network communication. The first RFFE 430 may include a duplexer 433, a filter 435, a low-noise amplifier (LNA) 437, and a power amplifier (PA) 431. In an embodiment, the duplexer 433 may include a transmission filter and a reception filter to allow the antenna module 450 to transmit and receive a signal. The antenna module 450 may receive a signal corresponding to non-terrestrial network communication. The signal received by the antenna module 450 may be transferred to the duplexer 433 through the antenna switch module 440. The RF signal output from the duplexer 433 may pass through the filter 435 and be input to the LNA 437. The signal in the frequency band corresponding to the non-terrestrial network communication output by the filter 435 may be amplified by the LNA 437. The signal amplified by the LNA 437 may be transferred to at least one RFIC 420. In an embodiment, the RF signal output from the at least one RFIC 420 may be amplified by the PA 431. The signal amplified by the PA 431 may be transferred to the antenna module 450 through the duplexer 433 and the antenna switch module 440. The antenna module 450 may transmit a signal corresponding to non-terrestrial network communication, based on the signal amplified by the PA 431.

In an embodiment, the at least one RFIC 420 (e.g., the first RFIC 222, the second RFIC 224, the third RFIC 226, and/or the fourth RFIC 228) may output an RF signal in a frequency band corresponding to non-terrestrial network communication upon transmission. At least one RFIC 420 may process the RF signal transferred by the first RFFE 430 upon reception. The signal converted to the baseband by the at least one RFIC 420 may be transferred to the communication processor 410 through at least one signal line 411.

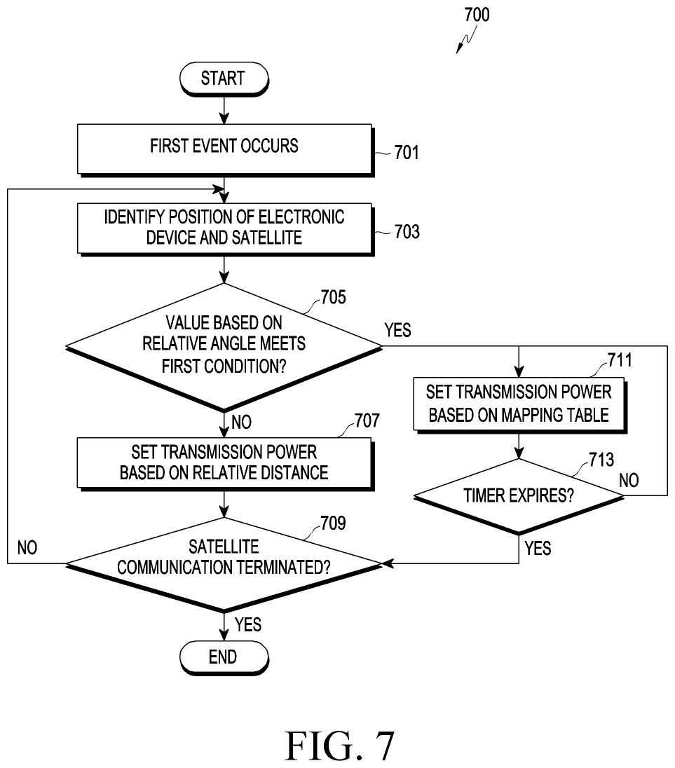

In an embodiment, at least one communication processor 410 (e.g., the processor 120, the first communication processor 212, the second communication processor 214, and/or the integrated communication processor 260) may set the transmission power of the RF signal. The communication processor 410 may set the transmission power of the RF signal based on transmission of a control signal to the at least one RFIC 420 through the control line 413. The operation of controlling at least one RFIC 420 to reduce current consumption to perform non-terrestrial network communication by the communication processor 410 is described in greater detail below with reference to FIGS. 7 to 11. In an embodiment, the electronic device (e.g., the electronic device 101) may further include the components illustrated in FIG. 1, 2A, or 2B, in addition to the components illustrated in FIG. 4.

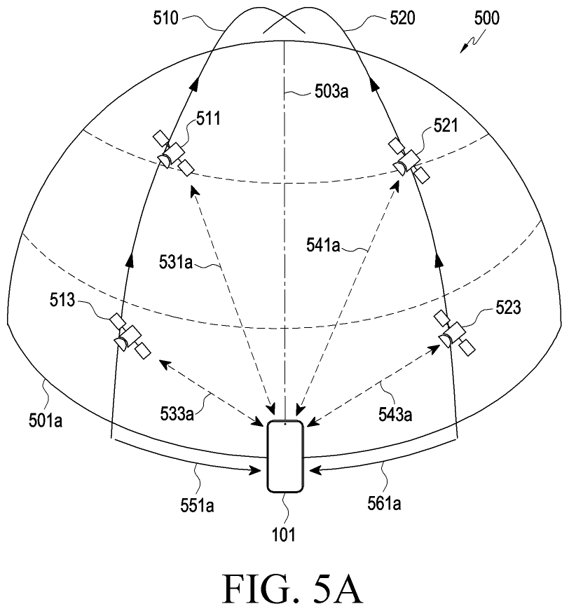

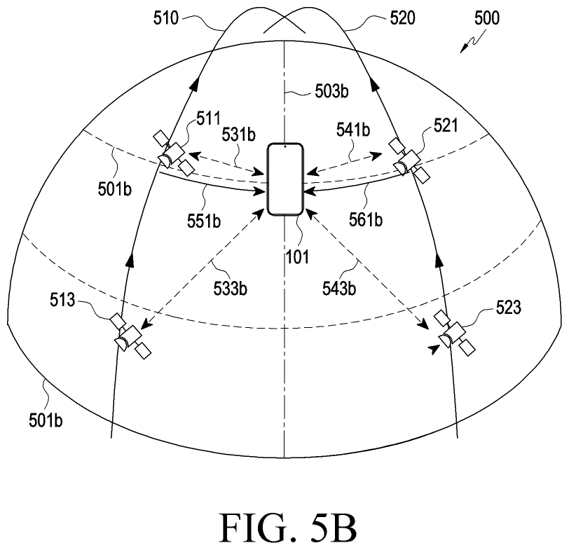

FIG. 5A is a diagram illustrating a satellite communication system according to various embodiments.

In an embodiment, referring to FIG. 5A, the electronic device 101 may perform positioning based on receiving a GPS signal. The electronic device 101 may identify a position including the latitude 501a and the longitude 503a of the electronic device 101, based on the GPS signal. For example, the latitude 501a of the electronic device 101 may be a low latitude around the equator. In an embodiment, a plurality of satellites 511, 513, 521, and 523 may travel around the Earth 500 along a preset orbit. For example, some 511 and 513 of the plurality of satellites may move along a first orbit 510. Some 521 and 523 of the plurality of satellites may move along a second orbit 520. In an embodiment, one orbit may include about 11 satellites, and the satellite communication system may include about 6 orbits, but is not limited thereto. The electronic device 101 may identify relative distances 531a, 533a, 541a, and 543a to at least one of the satellites 511, 513, 521, and 523 based on the identification of the latitude 501a and the longitude 503a. The electronic device 101 may identify the relative angles 551a and 561a to the orbits 510 and 520 corresponding to at least one of the satellites 511, 513, 521, and 523 based on the identification of the longitude 503a.

FIG. 5B is a diagram illustrating a satellite communication system according to various embodiments.

In an embodiment, referring to FIG. 5B, the electronic device 101 may perform positioning based on receiving a GPS signal. The electronic device 101 may identify a position including the latitude 501b and the longitude 503b of the electronic device 101, based on the GPS signal. For example, the latitude 501b of the electronic device 101 may be a mid latitude or a high latitude around about 60 degrees north. The electronic device 101 may identify relative distances 531b, 533b, 541b, and 543b to at least one of the satellites 511, 513, 521, and 523 based on the identification of the latitude 501b and the longitude 503b. The electronic device 101 may identify the relative angles 551b and 561b to the orbits 510 and 520 corresponding to at least one of the satellites 511, 513, 521, and 523, based on the identification of the longitude 503b.

In an embodiment, comparison between FIGS. 5A and 5B reveals that the maximum distance between at least one satellite and the electronic device 101 may vary depending on the latitude of the electronic device 101. For example, referring to FIG. 5A, when the electronic device 101 is positioned between 0 and 20 degrees north or south, the distances 531a, 533a, 541a, and 543a between the at least one satellite and the electronic device 101 may be relatively increased. Referring to FIG. 5B, when the latitude of the electronic device 101 is within 40 to 90 degrees north or south, the distances 531b, 533b, 541b, and 543b between the at least one satellite and the electronic device 101 may be relatively reduced.

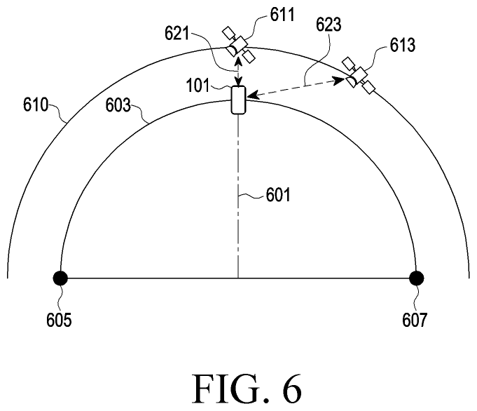

FIG. 6 is a diagram illustrating a relative distance between an electronic device and a satellite according to various embodiments.

In an embodiment, referring to FIG. 6, the electronic device 101 may identify a latitude 601 and a longitude 603 based on a GPS signal. The at least one satellite 611 or 613 may circle the Earth through the South Pole 605 and the North Pole 607 along a predetermined orbit 610. For example, the latitude 601 of the electronic device 101 may be a low latitude near the equator, and the longitude 603 of the electronic device 101 may be in the orbit 610 corresponding to the at least one satellite 611 or 613. In an embodiment, although FIG. 6 illustrates that the longitude 603 of the electronic device 101 is in the orbit 610 corresponding to the at least one satellite 611 or 613 without considering the rotation of the Earth, those skilled in the art will understand that the longitude 603 of the electronic device 101 may deviate from the orbital axis corresponding to the at least one satellite 611 or 613 as the Earth rotates. In an embodiment, the electronic device 101 may identify at least one of the relative distance 621 to the closest satellite 611 or the relative distance 623 to the farthest satellite 613 based on identifying the position of the electronic device 101. For example, the relative distance 621 to the closest satellite 611 may be a distance from the satellite 611 in a direction orthogonal to the ground, and may be about 783 km, but is not limited thereto. The relative distance 623 to the farthest satellite 613 may be about 2465 km when the latitude of the electronic device 101 is the equator, but is not limited thereto. To perform non-terrestrial network communication, the electronic device 101 may transmit a signal corresponding to the non-terrestrial network communication with transmission power of about 36.5 dBm whenever a trigger for the non-terrestrial network communication occurs. For example, the trigger for non-terrestrial network communication may be a user input for performing satellite communication. When the electronic device 101 continuously transmits a signal corresponding to non-terrestrial network communication without considering the relative distance to the satellites 611 and 613, the average current consumption of the electronic device 101 may increase. In an embodiment, referring to Table 1, when the relative distance to the satellite is relatively small, the electronic device 101 may meet the minimum SNR for performing satellite communication even if the transmission power of the signal corresponding to the non-terrestrial network communication is reduced.

TABLE 1

| Satellite Rx signal | Transmission | Relative | |
|---|---|---|---|
| level [dBm] | power [dBm] | distance [km] | SNR [dB] |
| −101.3350138 | 36.5 | 783 | 21.47529 |
| −111.8350138 | 26 | 783 | 12.87529 |
| −111.296117 | 36.5 | 2465 | 13.41418 |

In an embodiment, the maximum transmission power of the electronic device 101 may be set to 36.5 dBm. For example, referring to Table 1, when the relative distance is about 2465 km, the electronic device 101 may secure an SNR of about 13 dB based on transmitting a signal corresponding to non-terrestrial network communication with transmission power of about 36.5 dBm. When the relative distance is about 783 km, the electronic device 101 may secure an SNR of about 21 dB based on transmission of a signal corresponding to non-terrestrial network communication with transmission power of about 36.5 dBm. When the relative distance is about 783 km, the electronic device 101 may secure an SNR of about 12 to 13 dB based on transmission of a signal corresponding to non-terrestrial network communication with transmission power of about 26 dBm. When the relative distance is relatively small, the electronic device 101 may meet the minimum SNR for performing satellite communication, based on setting the power lower than the maximum transmission power to the transmission power of the signal corresponding to the non-terrestrial network communication.

FIG. 7 is a flowchart 700 illustrating an example method of operating an electronic device according to various embodiments.

According to an embodiment, the electronic device 101 (e.g., the processor 120, the first communication processor 212, the second communication processor 214, the integrated communication processor 260, and/or the communication processor 410) may identify the occurrence of a first event in operation 701. For example, the electronic device 101 may identify a trigger for satellite communication, based on a user input for performing satellite communication. Triggers for satellite communication are not limited to the above-described examples.

In an embodiment, the electronic device 101 may identify the position of the electronic device 101 and the satellite in operation 703, based on identifying the occurrence of the first event. In an embodiment, the electronic device 101 may identify the position of the electronic device 101 and at least one satellite from the GPS signal. Based on identifying the latitude and longitude of the electronic device 101, the electronic device 101 may identify the position of at least one satellite circling along a preset orbit. For example, the electronic device 101 may identify the position of the satellite traveling closest to the position of the electronic device 101. The electronic device 101 may further identify the position of at least one satellite adjacent to the satellite traveling closest thereto. In an embodiment, the plurality of satellites may move in a predetermined orbit at a predetermined speed and order. The electronic device 101 may identify the satellite closest to the electronic device 101 and the satellite to be moved to the position closest to the electronic device 101, based on information about the orbits, speeds, and order of the plurality of satellites previously stored in the memory (e.g., the memory 130). The electronic device 101 may estimate the moving path of each of the plurality of satellites and the relative distance to the electronic device 101 over time, based on the pre-stored information.

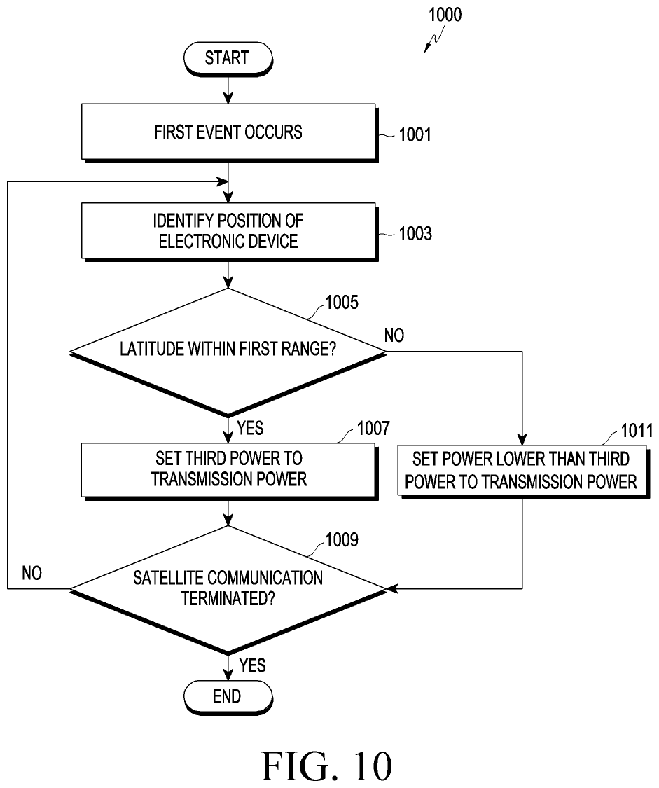

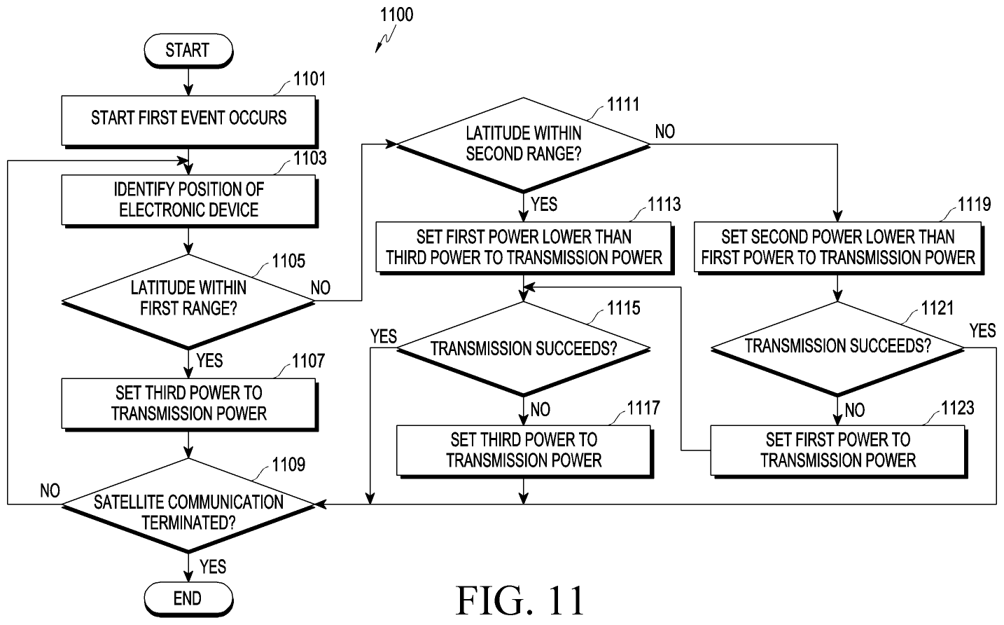

In an embodiment, the electronic device 101 may identify whether the value based on the relative angle meets the first condition in operation 705, based on identifying the positions of the electronic device and the satellite. For example, the first condition may be that the difference between the longitude of the electronic device 101 and the longitude of the satellite orbit adjacent thereto is within a threshold angle. The electronic device 101 may identify whether a relative angle between the orbital axis corresponding to at least one satellite and the electronic device 101 is within a threshold angle. For example, the threshold angle may be about 5 degrees, but is not limited thereto. The electronic device 101 may identify whether the relative angle is within the threshold angle, based on comparing the identified longitude corresponding to the position of the electronic device 101 with the longitude of the orbital axis corresponding to at least one satellite. In an embodiment, the latitude of the electronic device 101 may be within a first range. For example, the electronic device 101 may be positioned within a low latitude of 20 degrees or less north or south. The first range is not limited to the above-described example. As described above with reference to FIGS. 5A and 5B, as the latitude of the electronic device 101 increases, the relative distance to the satellite may decrease. When the latitude of the electronic device 101 is within the high latitude, the electronic device 101 may control the transmission power based only on the latitude information. An example in which the electronic device 101 controls transmission power based only on latitude information is described in greater detail below with reference to FIGS. 10 and 11.

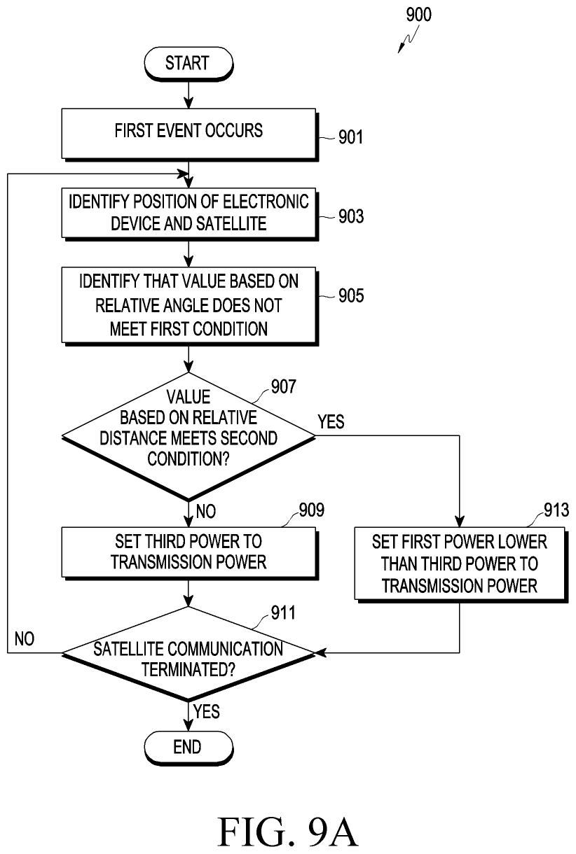

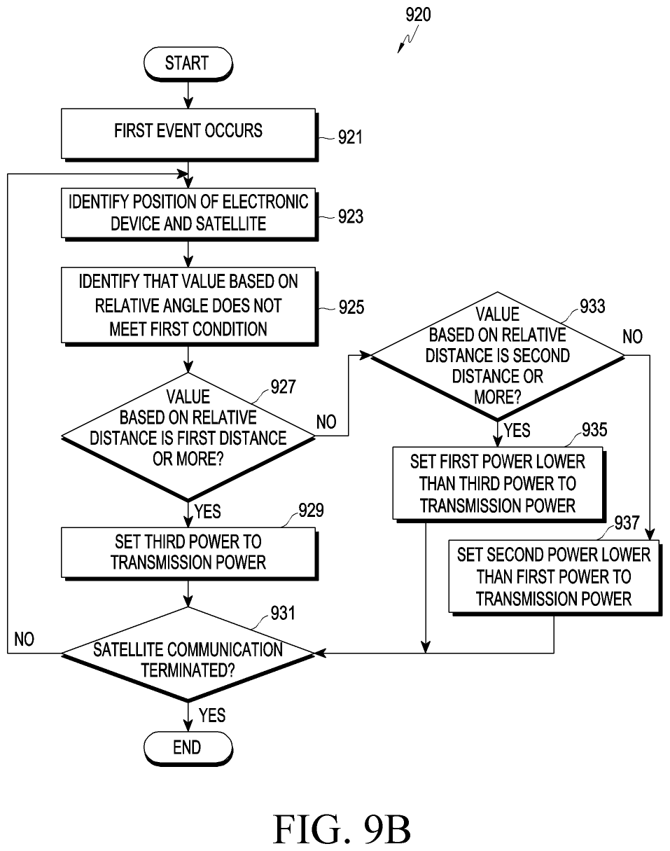

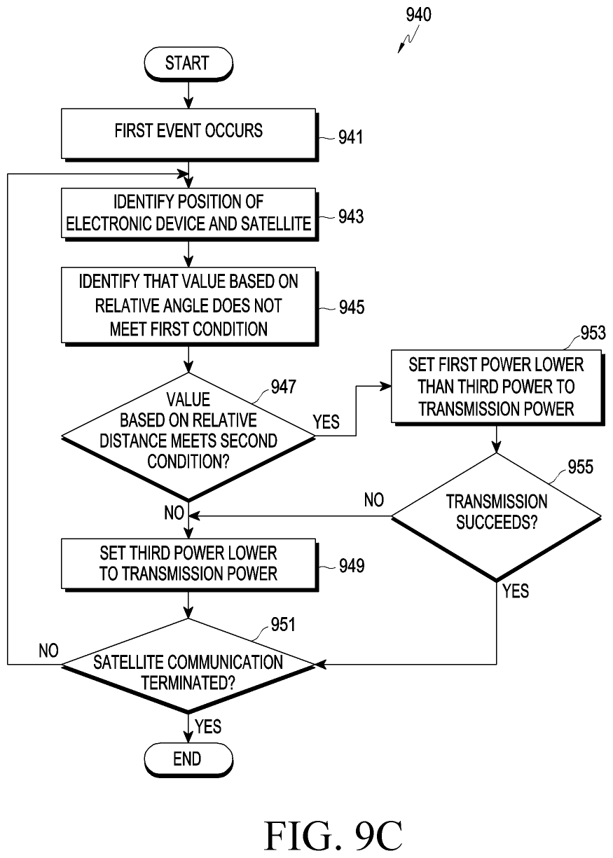

In an embodiment, when the value based on the relative angle does not meet the first condition (No in operation 705), the electronic device 101 may set transmission power based on the relative distance in operation 707. For example, when the longitude of the electronic device 101 deviates from the axis of the adjacent satellite orbit by 5 degrees or more, the electronic device 101 may set the transmission power based on the relative distance to the satellite. After setting the transmission power, the electronic device 101 may transmit a signal corresponding to the non-terrestrial network communication based on the set transmission power. An example in which the electronic device 101 sets transmission power based on the relative distance is described in greater detail below with reference to FIGS. 9A and 9B.

In an embodiment, when the value based on the relative angle meets the first condition (Yes in operation 705), the electronic device 101 may set transmission power based on the mapping table in operation 711. In an embodiment, referring to Table 2, the electronic device 101 may set the transmission power of the signal corresponding to the satellite communication, based on a mapping table associated with the setting of the transmission power corresponding to the time range.

TABLE 2

| Time | Relative distance | Transmission power | Nearest |
|---|---|---|---|
| [m] | [km] | [dBm] | satellite |
| t = 0 | d = 783 | 28 | s = 0 |
| t = 1 | Δd = 468 | 30 | s = 0 |
| t = 2 | Δd = 963 | 33 | s = 0 |
| t = 3 | Δd = 1404 | 36.5 | s = 0 |
| t = 4 | d = 2187 | 33 | s = 1 |
| t = 5 | Δd = 468 | 30 | s = 1 |

In an embodiment, referring to Table 2, when the electronic device 101 initially fixes transmission power based on the mapping table, the satellite closest to the electronic device 101 may be a satellite labeled 0. The relative distance between the electronic device 101 and satellite 0 may be about 783 km. The electronic device 101 may set the power of about 28 dBm pre-mapped corresponding to the relative distance of about 783 km as the transmission power corresponding to the non-terrestrial network communication. Considering that the relative distance increases as satellite 0 moves, the electronic device 101 may increase transmission power every minute. For example, the electronic device 101 may set the maximum transmission power of about 36.5 dBm as the transmission power of the signal corresponding to the non-terrestrial network communication, considering that the relative distance between the electronic device 101 and satellite 0 is maximized 3 minutes after the transmission power is initially fixed. The variable time of the transmission power may be changed according to the moving speed of the satellite, and is not limited to the above-described example. For example, a low earth orbit (LEO) may move at about 7.8 km/s above about 500 km to 2000 km, but is not limited thereto. The electronic device 101 may identify the satellite labeled 1 as the satellite closest to the electronic device 101, 4 minutes after the transmission power is initially fixed. Considering that the relative distance between the first satellite and the electronic device 101 decreases over time, the electronic device 101 may reduce the transmission power of the signal corresponding to the non-terrestrial network communication every minute. For example, the electronic device 101 may reduce the transmission power from about 33 dBm to about 30 dBm 5 minutes after the transmission power is initially fixed. In an embodiment, the electronic device 101 may vary transmission power based on a pre-stored mapping table without identifying the current position of the satellite based on communication with the satellite.

In an embodiment, after setting the transmission power based on the mapping table, the electronic device 101 may identify whether a timer expires in operation 713. Considering that the relative angle between the axis of the orbit where satellites 0 and 1 belong and the electronic device 101 in Table 2 increases due to the rotation of the Earth, the electronic device 101 may terminate the control of the transmission power based on the mapping table, based on a timer having a predetermined length. For example, the timer may be about 30 minutes, but is not limited thereto.

In an embodiment, the electronic device 101 may identify whether the satellite communication is terminated in operation 709. For example, the electronic device 101 may identify that the satellite communication is terminated, based on identifying the trigger for terminating the satellite communication. When the satellite communication is not terminated (No in operation 709), the electronic device 101 may identify the position of the electronic device and the satellite in operation 703.

In an embodiment, when transmitting a signal corresponding to non-terrestrial network communication, the electronic device 101 may change the magnitude of transmission power, based on identifying the relative angle to the satellite orbital axis and/or the relative distance to the satellite. The electronic device 101 may reduce the average current consumption of the electronic device 101 and may increase the use time of the electronic device 101, based on changing the magnitude of the transmission power.

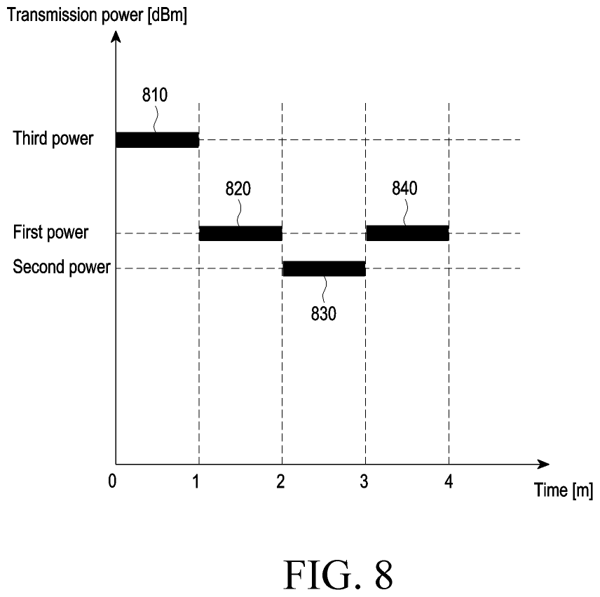

FIG. 8 is a graph illustrating an example of controlling transmission power over time by an electronic device according to various embodiments.

In an embodiment, the electronic device 101 may change the transmission power of the signal corresponding to the non-terrestrial network communication, based on a predetermined mapping table. For example, the electronic device 101 may set (810) the maximum power from 0 minutes to 1 minute to the transmission power. The electronic device 101 may transmit a signal corresponding to non-terrestrial network communication with maximum power from 0 minutes to 1 minute. In an embodiment, the frequency band of the signal may be about 1.6 GHz, but is not limited thereto. Considering that the relative distance to the satellite closest to the electronic device 101 decreases over time, the electronic device 101 may set (820) the first power lower than the maximum power from 1 minute to 2 minutes as the transmission power. The electronic device 101 may transmit a signal corresponding to non-terrestrial network communication with first power from 1 minute to 2 minutes. Considering that the relative distance to the satellite closest to the electronic device 101 is further reduced over time, the electronic device 101 may set (830) the second power lower than the first power from 2 minutes to 3 minutes as the transmission power. The electronic device 101 may transmit a signal corresponding to non-terrestrial network communication with the second power from 2 minutes to 3 minutes. Considering that the relative distance to the satellite closest to the electronic device 101 increases over time, the electronic device 101 may set (840) the first power higher than the second power from 3 minutes to 4 minutes as the transmission power. The electronic device 101 may transmit a signal corresponding to non-terrestrial network communication with first power from 3 minute to 4 minutes.

In an embodiment, the electronic device 101 may reduce the average current consumption of the electronic device 101, based on varying the transmission power of the signal, in contrast to the case of transmitting the signal corresponding to the non-terrestrial network communication with the maximum power from 0 minutes to 4 minutes.

FIG. 9A is a flowchart 900 illustrating an example method of operating an electronic device according to various embodiments.

According to an embodiment, the electronic device 101 (e.g., the processor 120, the first communication processor 212, the second communication processor 214, the integrated communication processor 260, and/or the communication processor 410) may identify the occurrence of a first event in operation 901. Since operation 901 is at least partially the same as operation 701, the description overlapping operation 701 may not be repeated.

In an embodiment, the electronic device 101 may identify the position of the electronic device and the satellite in operation 903, based on identifying the occurrence of the first event. Since operation 903 is at least partially the same as operation 703, the description overlapping operation 703 may not be repeated.

In an embodiment, the electronic device 101 may identify that the value based on the relative angle does not meet the first condition in operation 905, based on identifying the positions of the electronic device and the satellite. For example, the electronic device 101 may identify that the difference between the longitude of the electronic device 101 and the longitude of the satellite orbit axis adjacent thereto is a threshold angle or more.

In an embodiment, the electronic device 101 may identify whether the value based on the relative distance meets a second condition in operation 907. In an embodiment, the second condition may be that the relative distance is less than the first distance. For example, the first distance may be about 2000 km, but is not limited thereto. In an embodiment, the relative distance between the electronic device 101 and the satellite may be a relative distance considering the relative distance to the closest satellite, the average value of the relative distances to the plurality of satellites, or the power for transmitting the transmission signal to the farthest satellite.

In an embodiment, when the value based on the relative distance does not meet the second condition (No in operation 907), the electronic device 101 may set the third power as transmission power in operation 909. In an embodiment, the third power may be the settable maximum power of the electronic device 101. For example, based on identifying that the relative distance to the satellite closest to the electronic device 101 is about 2000 km or more, the electronic device 101 may set the power of about 36.5 dBm as the transmission power of the signal in order to meet the minimum SNR for non-terrestrial network communication, and specific numerical values are not limited thereto. After setting the transmission power, the electronic device 101 may transmit a signal corresponding to the non-terrestrial network communication based on the set transmission power.

In an embodiment, when the value based on the relative distance meets the second condition (Yes in operation 907), the electronic device 101 may set the first power lower than the third power as the transmission power in operation 913. For example, based on identifying that the relative distance is about 1000 km or more and less than about 2000 km, the electronic device 101 may set the power of about 33 dBm as the transmission power, and specific numerical values are not limited thereto. After setting the transmission power, the electronic device 101 may transmit a signal corresponding to the non-terrestrial network communication based on the set transmission power.

In an embodiment, the electronic device 101 may identify whether the satellite communication is terminated in operation 911. When the satellite communication is not terminated (No in operation 911), the electronic device 101 may identify the position of the electronic device and the satellite in operation 903.

FIG. 9B is a flowchart 920 illustrating an example method of operating an electronic device according to various embodiments.

According to an embodiment, the electronic device 101 (e.g., the processor 120, the first communication processor 212, the second communication processor 214, the integrated communication processor 260, and/or the communication processor 410) may identify the occurrence of a first event in operation 921. Since operation 921 is at least partially the same as operation 701, the description overlapping operation 701 may not be repeated.

In an embodiment, the electronic device 101 may identify the position of the electronic device and the satellite in operation 923, based on identifying the occurrence of the first event. Since operation 923 is at least partially the same as operation 703, the description overlapping operation 703 may not be repeated.

In an embodiment, the electronic device 101 may identify that the value based on the relative angle does not meet the first condition in operation 925, based on identifying the positions of the electronic device and the satellite. Since operation 925 is at least partially the same as operation 905, the description overlapping operation 905 may not be repeated.

In an embodiment, the electronic device 101 may identify whether the value based on the relative distance is a first distance or more in operation 927. For example, the electronic device 101 may identify whether the relative distance is about 2000 km or more, and specific numerical values are not limited.

In an embodiment, when the value based on the relative distance is the first distance or more (Yes in operation 927), the electronic device 101 may set the third power as the transmission power in operation 929. In an embodiment, the third power may be the settable maximum power of the electronic device 101. After setting the transmission power, the electronic device 101 may transmit a signal corresponding to the non-terrestrial network communication based on the set transmission power. Since operation 929 is at least partially the same as operation 909, the description overlapping operation 909 may not be repeated.

In an embodiment, when the value based on the relative distance is less than the first distance (No in operation 927), the electronic device 101 may identify whether the value based on the relative distance is a second distance or more in operation 933. For example, the electronic device 101 may identify whether the value based on the relative distance is about 1000 km or more, and specific numerical values are not limited.

In an embodiment, when the value based on the relative distance is the second distance or more (Yes in operation 933), the electronic device 101 may set the first power lower than the third power as the transmission power in operation 935. After setting the transmission power, the electronic device 101 may transmit a signal corresponding to the non-terrestrial network communication based on the set transmission power. Since operation 935 is at least partially the same as operation 913, the description overlapping operation 913 may not be repeated.

In an embodiment, when the value based on the relative distance is the second distance or more (No in operation 933), the electronic device 101 may set the second power lower than the first power as the transmission power in operation 937. For example, based on identifying that the relative distance is less than about 1000 km, the electronic device 101 may set the power of about 28 dBm as the transmission power of the signal. After setting the transmission power, the electronic device 101 may transmit a signal corresponding to the non-terrestrial network communication based on the set transmission power.

In an embodiment, the electronic device 101 may identify whether the satellite communication is terminated in operation 931. When the satellite communication is not terminated (No in operation 931), the electronic device 101 may identify the position of the electronic device and the satellite in operation 923.

In an embodiment, referring to Table 3, the electronic device 101 may change transmission power based on the relative distance.

TABLE 3

| Mapping Table | Condition [km] | Transmission power [dBm] |
|---|---|---|
| Case 1 | d < 1000 | 28 |
| Case 2 | 1000 ≤ d < 2000 | 33 |
| Case 3 | 2000 ≤ d | 36.5 |

In an embodiment, based on identifying that the relative distance is less than about 1000 km, the electronic device 101 may set the power of about 28 dBm to the transmission power of the signal. Based on identifying that the relative distance is about 1000 km or more and less than about 2000 km, the electronic device 101 may set the power of about 33 dBm to the transmission power. Based on identifying that the relative distance to the satellite closest to the electronic device 101 is about 2000 km or more, the electronic device 101 may set the power of about 36.5 dBm as the transmission power of the signal in order to meet the minimum SNR of about 5 to 6 dB for non-terrestrial network communication.

FIG. 9C is a flowchart 940 illustrating an example method of operating an electronic device according to various embodiments.

According to an embodiment, the electronic device 101 (e.g., the processor 120, the first communication processor 212, the second communication processor 214, the integrated communication processor 260, and/or the communication processor 410) may identify the occurrence of a first event in operation 921. Since operation 941 is at least partially the same as operation 701, the description overlapping operation 701 may not be repeated.

In an embodiment, the electronic device 101 may identify the position of the electronic device and the satellite in operation 943, based on identifying the occurrence of the first event. Since operation 943 is at least partially the same as operation 703, the description overlapping operation 703 may not be repeated.

In an embodiment, the electronic device 101 may identify that the value based on the relative angle does not meet the first condition in operation 945, based on identifying the positions of the electronic device and the satellite. Since operation 945 is at least partially the same as operation 905, the description overlapping operation 905 may not be repeated.

In an embodiment, the electronic device 101 may identify whether the value based on the relative distance meets a second condition in operation 947. Since operation 947 is at least partially the same as operation 907, the description overlapping operation 907 may not be repeated.

In an embodiment, when the value based on the relative distance does not meet the second condition (No in operation 947), the electronic device 101 may set the third power as transmission power in operation 949. In an embodiment, the third power may be the settable maximum power of the electronic device 101. For example, based on identifying that the relative distance to the satellite closest to the electronic device 101 is about 2000 km or more, the electronic device 101 may set the power of about 36.5 dBm as the transmission power of the signal in order to meet the minimum SNR for non-terrestrial network communication, and specific numerical values are not limited thereto. After setting the transmission power, the electronic device 101 may transmit a signal corresponding to the non-terrestrial network communication based on the set transmission power.

In an embodiment, when the value based on the relative distance meets the second condition (Yes in operation 947), the electronic device 101 may set the first power lower than the third power as the transmission power in operation 953. For example, based on identifying that the relative distance is about 1000 km or more and less than about 2000 km, the electronic device 101 may set the power of about 33 dBm as the transmission power, and specific numerical values are not limited thereto. After setting the transmission power, the electronic device 101 may transmit a signal corresponding to the non-terrestrial network communication based on the set transmission power.

In an embodiment, the electronic device 101 may identify whether transmission of the signal is successful in operation 955, based on setting the first power lower than the third power to the transmission power. When the electronic device 101 receives a message indicating that the transmission of the signal is successful from the satellite communication network, the electronic device 101 may identify that the transmission of the signal is successful. Based on identifying that transmission of the signal is successful (Yes in operation 955), the electronic device 101 may identify whether satellite communication is terminated in operation 951. When the electronic device 101 does not receive the message indicating that the transmission of the signal is successful from the satellite communication network, the electronic device 101 may identify that the transmission of the signal fails. Based on identifying that transmission of the signal fails (No in operation 955), the electronic device 101 may set the third power to the transmission power in operation 949. Based on identifying that satellite communication fails, the electronic device 101 may set the transmittable maximum power of the electronic device 101 to the transmission power of the transmission signal corresponding to the satellite communication.

In an embodiment, the electronic device 101 may identify whether the satellite communication is terminated in operation 951. When the satellite communication is not terminated (No in operation 951), the electronic device 101 may identify the position of the electronic device and the satellite in operation 943.

FIG. 10 is a flowchart 1000 illustrating an example method of operating an electronic device according to various embodiments.

According to an embodiment, the electronic device 101 (e.g., the processor 120, the first communication processor 212, the second communication processor 214, the integrated communication processor 260, and/or the communication processor 410) may identify the occurrence of a first event in operation 1001. Since operation 1001 is at least partially the same as operation 701, the description overlapping operation 701 may not be repeated.

In an embodiment, the electronic device 101 may identify the position of the electronic device and the satellite in operation 1003, based on identifying the occurrence of the first event. Since operation 1003 is at least partially the same as operation 703, the description overlapping operation 703 may not be repeated.

In an embodiment, the electronic device 101 may identify whether the latitude is within a first range in operation 1005, based on identifying the positions of the electronic device and the satellite. For example, the electronic device 101 may determine whether the latitude is about 20 degrees or less north or south, but specific numerical values are not limited thereto.

In an embodiment, when the latitude is within the first range (Yes in operation 1005), the electronic device 101 may set the maximum power to the transmission power (e.g., third power) in operation 1007. For example, based on identifying that the latitude is a low latitude of about 20 degrees or less, the electronic device 101 may set the power of about 36.5 dBm to the transmission power of the signal corresponding to the non-terrestrial network communication, but specific numerical values are not limited thereto. After setting the transmission power, the electronic device 101 may transmit a signal corresponding to the non-terrestrial network communication based on the set transmission power.

In an embodiment, when the latitude is not within the first range (No in operation 1005), the electronic device 101 may set a power lower than the third power as transmission power in operation 1011. In an embodiment, the third power may be the settable maximum power of the electronic device 101. In an embodiment, when the latitude is greater than or equal to a mid latitude, the electronic device 101 may meet the SNR margin required by the satellite communication system, based on setting the power lower than the maximum power as the transmission power of the signal, considering that the relative distance to the satellite is relatively reduced. After setting the transmission power, the electronic device 101 may transmit a signal corresponding to the non-terrestrial network communication based on the set transmission power.

In an embodiment, the electronic device 101 may identify whether the satellite communication is terminated in operation 1009. When the satellite communication is not terminated (No in operation 1009), the electronic device 101 may identify the position of the electronic device and the satellite in operation 1003.

FIG. 11 is a flowchart 1100 illustrating an example method of operating an electronic device according to various embodiments.

According to an embodiment, the electronic device 101 (e.g., the processor 120, the first communication processor 212, the second communication processor 214, the integrated communication processor 260, and/or the communication processor 410) may identify the occurrence of a first event in operation 1101. Since operation 1101 is at least partially the same as operation 701, the description overlapping operation 701 may not be repeated.

In an embodiment, the electronic device 101 may identify the position of the electronic device and the satellite in operation 1103, based on identifying the occurrence of the first event. Since operation 1103 is at least partially the same as operation 703, the description overlapping operation 703 may not be repeated.

In an embodiment, the electronic device 101 may identify whether the latitude is within a first range in operation 1105, based on identifying the positions of the electronic device and the satellite. Since operation 1105 is at least partially the same as operation 1005, the description overlapping operation 1005 may not be repeated.

In an embodiment, when the latitude is within the first range (Yes in operation 1105), the electronic device 101 may set the third power to the transmission power in operation 1107. In an embodiment, the third power may be the settable maximum power of the electronic device 101. After setting the transmission power, the electronic device 101 may transmit a signal corresponding to the non-terrestrial network communication based on the set transmission power.

In an embodiment, when the latitude is not within the first range (No in operation 1105), the electronic device 101 may identify whether the latitude is within a second range in operation 1111. For example, the electronic device 101 may identify whether the latitude is within about 20 degrees to 60 degrees north or south.

In an embodiment, when the latitude is within the second range (Yes in operation 1111), the electronic device 101 may set the first power lower than the third power as the transmission power in operation 1113. For example, when the latitude is a mid latitude, the electronic device 101 may set a power about 3 dB lower than the settable maximum power of the electronic device 101 as the transmission power of the signal. After setting the transmission power, the electronic device 101 may transmit a signal corresponding to the non-terrestrial network communication based on the set transmission power.

In an embodiment, after transmitting the signal corresponding to the satellite communication with the first power, the electronic device 101 may identify whether transmission of the signal is successful in operation 1115. When the electronic device 101 receives a message indicating that the transmission of the signal is successful from the satellite communication network, the electronic device 101 may identify that the transmission of the signal is successful. When the electronic device 101 does not receive the message indicating that the transmission of the signal is successful from the satellite communication network, the electronic device 101 may identify that the transmission of the signal fails. When transmission of a signal fails, the electronic device 101 may provide a notification indicating failure.

In an embodiment, when transmission of the signal fails (No in operation 1115), the electronic device 101 may set the third power as the transmission power of the signal corresponding to satellite communication in operation 1117.

In an embodiment, when the latitude is not within the second range (No in operation 1111), the electronic device 101 may set the second power lower than the first power as the transmission power in operation 1119. For example, the electronic device 101 may identify whether the latitude is within about 60 degrees to about 90 degrees north or south.

For example, the electronic device 101 may transmit a power about 6 dB lower than the maximum power as the transmission power of the signal, but specific numerical values are not limited thereto. After setting the transmission power, the electronic device 101 may transmit a signal corresponding to the non-terrestrial network communication based on the set transmission power.

In an embodiment, after transmitting the signal corresponding to the non-terrestrial network communication with the second power, the electronic device 101 may identify whether transmission of the signal is successful in operation 1121.

In an embodiment, if the transmission of the signal fails (No in operation 1121), the electronic device 101 may set the first power as the transmission power of the signal corresponding to the satellite communication in operation 1123. After setting the transmission power, the electronic device 101 may transmit a signal corresponding to the non-terrestrial network communication based on the set transmission power.

In an embodiment, the electronic device 101 may identify whether the satellite communication is terminated in operation 1009. When the satellite communication is not terminated (No in operation 1009), the electronic device 101 may identify the position of the electronic device and the satellite in operation 1003.

In an embodiment, the electronic device 101 may change the transmission power of the signal corresponding to the non-terrestrial network communication based on identifying only the latitude of the electronic device 101. The electronic device 101 may relatively reduce the average current consumption of the electronic device 101 as compared to the case where the maximum power is fixed to the transmission power of the signal.

According to an example embodiment, an electronic device (e.g., electronic device 101 in FIG. 1), may comprise: memory (e.g., memory 130 in FIG. 1, 2A, or 2B), storing instructions and at least one processor comprising processing circuitry (e.g., processor 120 in FIG. 1, 2A, or 2B, first communication processor 212, second communication processor 214 in FIG. 2A, integrated communication processor 260 in FIG. 2B, and/or communication processor 410 in FIG. 4.) The instructions, when executed by at least one processor, individually and/or collectively, may cause the electronic device to: identify a position of the electronic device and at least one satellite from a GPS signal based on identifying a first event; identify whether a value based on a relative angle between a trajectory axis corresponding to the at least one satellite and the electronic device satisfies a first condition; identify whether a value based on a relative distance between the electronic device and the at least one satellite satisfies a second condition based on identifying that the value based on the relative angle does not satisfy the first condition; set a first power lower than a third power to a transmission power of a transmission signal corresponding to satellite communication based on identifying the value based on the relative distance satisfying the second condition; and set a third power to a transmission power of a transmission signal corresponding to satellite communication based on identifying that the value based on the relative distance does not satisfy the second condition.

According to an example embodiment, the third power may be a settable maximum power of the electronic device.

According to an example embodiment, the instructions, when executed by at least one processor, individually and/or collectively, may cause the electronic device to, as at least part of identifying whether the value based on the relative distance between the electronic device and the at least one satellite satisfies the second condition based on identifying that the value based on the relative angle does not satisfy the first condition, identify whether the value based on the relative distance is equal to or greater than a first distance; identify whether the value based on the relative distance is equal to or greater than a second distance based on identifying the value based on the relative distance being less than the first distance; and set the first power lower than the third power to the transmission power of the transmission signal corresponding to the satellite communication based on identifying the value based on the relative distance being equal to or greater than the second distance.

According to an example embodiment, the instructions, when executed by at least one processor, individually and/or collectively, may cause the electronic device to set a second power lower than the first power to the transmission power of the transmission signal corresponding to the satellite communication based on identifying the value based on the relative distance being less than the second distance.

According to an example embodiment, the instructions, when executed by at least one processor, individually and/or collectively, may cause the electronic device to, based on the value based on the relative angle satisfying a first condition, set the transmission power of the transmission signal corresponding to the satellite communication based on a mapping table associated with a setting of a transmission power corresponding to a time period.

According to an example embodiment, the instructions, when executed by at least one processor, individually and/or collectively, may cause the electronic device to: initiate a first timer after setting the transmission power of the transmission signal corresponding to the satellite communication based on the mapping table; and set the transmission power of the transmission signal corresponding to the satellite communication based on the mapping table until the first timer expires.

According to an example embodiment, an electronic device, may comprise memory, storing instructions and at least one processor, comprising processing circuitry, (e.g., processor 120 in FIG. 1, 2A, or 2B, first communication processor 212, second communication processor 214 in FIG. 2A, integrated communication processor 260 in FIG. 2B, and/or communication processor 410 in FIG. 4.) The instructions, when executed by at least one processor 120, 212, 214, 260, or 410 may cause the electronic device to: identify a position of the electronic device from a GPS signal based on identifying a first event; identify whether a latitude corresponding to the position of the electronic device is within a first range; and set a power lower than a third power to a transmission power of a transmission signal corresponding to satellite communication based on identifying that the latitude corresponding to the position of the electronic device is not within the first range.

According to an example embodiment, the instructions, when executed by at least one processor, individually and/or collectively, may cause the electronic device to set the third power to the transmission power based on identifying the latitude corresponding to the position of the electronic device being within the first range.

According to an example embodiment, the instructions, when executed by at least one processor, individually and/or collectively, may cause the electronic device to, as at least part of setting the power lower than the third power to the transmission power based on identifying that the latitude corresponding to the position of the electronic device is not within the first range, identify whether the latitude corresponding to the position of the electronic device is within a second range; and set a first power lower than the third power to the transmission power of the transmission signal corresponding to the satellite communication based on identifying the latitude corresponding to the position of the electronic device being within the second range.

According to an example embodiment, the instructions, when executed by at least one processor, individually and/or collectively, may cause the electronic device to, identify whether the transmission succeeds after transmitting the transmission signal with the first power; and set the third power to the transmission power of the transmission signal corresponding to the satellite communication based on identifying a failure of the transmission.

According to an example embodiment, the instructions, when executed by at least one processor, individually and/or collectively, may cause the electronic device to set a second power lower than the first power to the transmission power based on identifying that the latitude corresponding to the position of the electronic device is not within the second range.

According to an example embodiment, the instructions, when executed by at least one processor, individually and/or collectively, may cause the electronic device to, identify whether the transmission succeeds after transmitting the transmission signal with the second power; and set the first power to the transmission power of the transmission signal corresponding to the satellite communication based on identifying the failure of the transmission.

The electronic device according to an embodiment may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or Further, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
memory storing instructions; and
at least one processor, comprising processing circuitry,
wherein the instructions that, when executed by at least one processor, individually and/or collectively, is configured to, cause the electronic device to:
identify a position of the electronic device and at least one satellite from a GPS signal based on identifying a first event;
identify whether a value based on a relative angle between a trajectory axis corresponding to the at least one satellite and the electronic device satisfies a first condition;
identify whether a value based on a relative distance between the electronic device and the at least one satellite satisfies a second condition based on identifying that the value based on the relative angle does not satisfy the first condition;
set a first power lower than a third power to a transmission power of a transmission signal corresponding to satellite communication based on identifying the value based on the relative distance satisfying the second condition; and
set a third power to a transmission power of a transmission signal corresponding to satellite communication based on identifying that the value based on the relative distance does not satisfy the second condition.

2. The electronic device of claim 1, wherein the third power is a settable maximum power of the electronic device.

3. The electronic device of claim 1, wherein the instructions that, when executed by at least one processor, individually and/or collectively cause the electronic device to:
as at least part of identifying whether the value based on the relative distance between the electronic device and the at least one satellite satisfies the second condition based on identifying that the value based on the relative angle does not satisfy the first condition, identify whether the value based on the relative distance is equal to or greater than a first distance; and
wherein the instructions that, when executed by at least one processor, individually and/or collectively, cause the electronic device to:
identify whether the value based on the relative distance is equal to or greater than a second distance based on identifying the value based on the relative distance being less than the first distance; and
set the first power lower than the third power to the transmission power of the transmission signal corresponding to the satellite communication based on identifying the value based on the relative distance being equal to or greater than the second distance.

4. The electronic device of claim 3, wherein the instructions that, when executed by at least one processor, cause the electronic device to:
set a second power lower than the first power to the transmission power of the transmission signal corresponding to the satellite communication based on identifying the value based on the relative distance being less than the second distance.

5. The electronic device of claim 1, wherein the instructions that, when executed by at least one processor, individually and/or collectively, cause the electronic device to:
based on the value based on the relative angle satisfying a first condition, set the transmission power of the transmission signal corresponding to the satellite communication based on a mapping table associated with a setting of a transmission power corresponding to a time period.

6. The electronic device of claim 1, wherein the instructions that, when executed by at least one processor, individually and/or collectively, is configured to cause the electronic device to:
initiate a first timer after setting the transmission power of the transmission signal corresponding to the satellite communication based on the mapping table; and
set the transmission power of the transmission signal corresponding to the satellite communication based on the mapping table until the first timer expires.

7. An electronic device comprising:
memory storing instructions; and
at least one processor, comprising processing circuitry,
wherein the instructions that, when executed by at least one processor, individually and/or collectively, cause the electronic device to:
identify a position of the electronic device from a GPS signal based on identifying a first event;
identify whether a latitude corresponding to the position of the electronic device is within a first range; and
set a power lower than a third power to a transmission power of a transmission signal corresponding to satellite communication based on identifying that the latitude corresponding to the position of the electronic device is not within the first range.

8. The electronic device of claim 7, wherein the instructions that, when executed by at least one processor, individually and/or collectively, cause the electronic device to: set the third power to the transmission power based on identifying the latitude corresponding to the position of the electronic device being within the first range.

9. The electronic device of claim 7, wherein the instructions that, when executed by at least one processor, individually and/or collectively, cause the electronic device to:
as at least part of setting the power lower than the third power to the transmission power based on identifying that the latitude corresponding to the position of the electronic device is not within the first range,
identify whether the latitude corresponding to the position of the electronic device is within a second range; and
set a first power lower than the third power to the transmission power of the transmission signal corresponding to the satellite communication based on identifying the latitude corresponding to the position of the electronic device being within the second range.

10. The electronic device of claim 7,
wherein the instructions that, when executed by at least one processor, individually and/or collectively, cause the electronic device to:
identify whether the transmission succeeds after transmitting the transmission signal with the first power; and
set the third power to the transmission power of the transmission signal corresponding to the satellite communication based on identifying a failure of the transmission.

11. The electronic device of claim 7, wherein the instructions that, when executed by at least one processor, individually and/or collectively, cause the electronic device to: set a second power lower than the first power to the transmission power based on identifying that the latitude corresponding to the position of the electronic device is not within the second range.

12. The electronic device of claim 7, wherein the instructions that, when executed by at least one processor, individually and/or collectively, cause the electronic device to:
identify whether the transmission succeeds after transmitting the transmission signal with the second power; and
set the first power to the transmission power of the transmission signal corresponding to the satellite communication based on identifying the failure of the transmission.

13. A method of operating an electronic device, the method comprising:
identifying a position of the electronic device from a GPS signal based on identifying a first event;
identifying whether a value based on a relative angle between a trajectory axis corresponding to the at least one satellite and the electronic device satisfies a first condition;
identifying whether a value based on a relative distance between the electronic device and the at least one satellite satisfies a second condition based on identifying that the value based on the relative angle does not satisfy the first condition;
setting a first power lower than a third power to a transmission power of a transmission signal corresponding to satellite communication based on identifying the value based on the relative distance satisfying the second condition; and
setting a third power to a transmission power of a transmission signal corresponding to satellite communication based on identifying that the value based on the relative distance does not satisfy the second condition.

14. The method of claim 13, wherein the third power is a settable maximum power of the electronic device.

15. The method of claim 13, wherein identifying whether the value based on the relative distance between the electronic device and the at least one satellite satisfies the second condition based on identifying that the value based on the relative angle does not satisfy the first condition comprises identifying whether the value based on the relative distance is equal to or greater than a first distance, and
wherein the method further comprises:
identifying whether the value based on the relative distance is equal to or greater than a second distance based on identifying the value based on the relative distance being less than the first distance; and
setting the first power lower than the third power to the transmission power of the transmission signal corresponding to the satellite communication based on identifying the value based on the relative distance being equal to or greater than the second distance.

16. The method of claim 13, further comprising setting a second power lower than the first power to the transmission power of the transmission signal corresponding to the satellite communication based on identifying the value based on the relative distance being less than the second distance.

17. The method of claim 13, further comprising, based on the value based on the relative angle satisfying a first condition, setting the transmission power of the transmission signal corresponding to the satellite communication based on a mapping table associated with a setting of a transmission power corresponding to a time period.

18. A non-transitory storage medium storing computer-readable instructions that, when executed by at least one processor, individually and/or collectively, of an electronic device, cause the electronic device to perform at least one operation comprising:
identifying a position of the electronic device from a GPS signal based on identifying a first event;
identifying whether a value based on a relative angle between a trajectory axis corresponding to the at least one satellite and the electronic device satisfies a first condition;
identifying whether a value based on a relative distance between the electronic device and the at least one satellite satisfies a second condition based on identifying that the value based on the relative angle does not satisfy the first condition;
setting a first power lower than a third power to a transmission power of a transmission signal corresponding to satellite communication based on identifying the value based on the relative distance satisfying the second condition; and
setting a third power to a transmission power of a transmission signal corresponding to satellite communication based on identifying that the value based on the relative distance does not satisfy the second condition.

19. The storage medium of claim 18, wherein the identifying whether the value based on the relative distance between the electronic device and the at least one satellite satisfies the second condition based on identifying that the value based on the relative angle does not satisfy the first condition comprises identifying whether the value based on the relative distance is equal to or greater than a first distance, and
wherein the at least one operation further comprises:
identifying whether the value based on the relative distance is equal to or greater than a second distance based on identifying the value based on the relative distance being less than the first distance; and
setting the first power lower than the third power to the transmission power of the transmission signal corresponding to the satellite communication based on identifying the value based on the relative distance being equal to or greater than the second distance.

20. The storage medium of claim 18, wherein the at least one operation further comprises:
setting a second power lower than the first power to the transmission power of the transmission signal corresponding to the satellite communication based on identifying the value based on the relative distance being less than the second distance.
